(19) United States
(12) Patent Application Publication
(10) Pub. No.: US 2015/0340127 A1
(43) Pub. Date: Nov. 26, 2015

(54) SHIELDED WIRE, HARNESS, ELECTRICAL CIRCUIT, FABRIC, GARMENT AND SHEET

(71) Applicant: Hitachi Metals, Ltd., Tokyo (JP)

(72) Inventors: Detian HUANG, Hitachi (JP); Takanobu WATANABE, Hitachi (JP)

(21) Appl. No.: 14/625,312

(22) Filed: Feb. 18, 2015

(30) Foreign Application Priority Data
May 22, 2014 (JP) 2014-105999

(51) Int. Cl. H01B 7/22; H01B 3/30; H05B 3/34; H01B 7/00; A41D 13/005; A47C 21/04

(52) U.S. Cl. CPC H01B 7/226; A41D 13/0051; A47C 21/048; H05B 3/342; H01B 7/0009; H01B 3/30

(57) ABSTRACT

A shielded wire includes a center conductor, and an insulation layer and a shield that are sequentially formed on an outer periphery of the center conductor. The center conductor includes a high tensile-strength fiber and a plurality of metal strands wound around the high tensile-strength fiber.

The present application is based on Japanese patent application No. 2014-105999 filed on May 22, 2014, the entire contents of which are incorporated herein by reference.

### BACKGROUND OF THE INVENTION

1. Field of the Invention

The invention relates to a shielded wire, a harness, an electrical circuit, a fabric, a garment and a sheet.

2. Description of the Related Art

In recent years, a system capable of constantly monitoring the body condition and movement of patients rapidly prevails in the medical field. The system includes an electrical circuit incorporated in clothes and bed sheets. The electrical circuit incorporated into clothes or bed sheets may have a wiring formed of a conductive fiber or a metal fiber.

The related art to the invention of the present application may include JP-A-2010-133791.

### SUMMARY OF THE INVENTION

In case of using the conductive fiber or metal fiber as the wiring, a problem may arise that corrosion occurs in an environment constantly exposed to air or humidity and causes degradation in electrical characteristics. Also a noise contamination may occur especially in case of high-speed signal transmission.

In order to prevent the corrosion of signal transmission conductors and the noise contamination, it is desirable to use as the wiring a shielded wire having an insulation layer and a shield which are sequentially formed on the outer periphery of a center conductor.

However, the shielded wire has the problem that the center conductor may be broken when it is sewn into a fabric material etc. by a sewing machine.

It is an object of the invention to provide a shielded wire that is less likely to be broken when sewn into the fabric material, as well as a harness an electrical circuit, a fabric, a garment and a sheet using the shielded wire.

(1) According to one embodiment of the invention, a shielded wire comprises:

a center conductor; and

an insulation layer and a shield that are sequentially formed on an outer periphery of the center conductor,

wherein the center conductor comprises a high tensile-strength fiber and a plurality of metal strands wound around the high tensile-strength fiber.

In the above embodiment (1) of the invention, the following modifications and changes can be made.

(i) The insulation layer comprises a solid material of a fluoropolymer, and wherein the insulation layer is formed so as to be buried between the plural metal strands.

(ii) The shield comprises a metal tape wound on the insulation layer, and wherein the metal tape comprises a resin layer and a metal layer formed on one side of the resin layer.

(iii) The shield further comprises a resin tape wound on the insulation layer, the metal tape being wound around the resin tape so that the metal layer is located on an outer side, and wherein the resin tape and the metal tape are adhesively bonded by an adhesive layer provided on one or both of the resin tape and the metal tape.

(iv) The metal layer comprises aluminum.

(2) According to another embodiment of the invention, a harness comprises:

the shielded wire according to the above embodiment (1); and

a terminal component provided on at least one of end portions of the shielded wire.

(3) According to another embodiment of the invention, an electrical circuit comprises a wiring comprising the shielded wire according to the above embodiment (1).
(4) According to another embodiment of the invention, a fabric comprises:

a fabric material; and

the shielded wire according to the above embodiment (1) that is sewn into the fabric material.

(5) According to another embodiment of the invention, a garment comprises the fabric according to the above embodiment (4) that is cut and sewn.
(6) According to another embodiment of the invention, a sheet comprises:

a sheet-shaped base material; and

the shielded wire according to the above embodiment (1) that is sewn into the sheet-shaped base material.

### EFFECTS OF THE INVENTION

According to one embodiment of the invention, a shielded wire can be provided that is less likely to be broken when sewn into the fabric material, as well as a harness an electrical circuit, a fabric, a garment and a sheet using the shielded wire.

### BRIEF DESCRIPTION OF THE DRAWINGS

Next, the present invention will be explained in more detail in conjunction with appended drawings, wherein:

FIGS. 1A and 1B are diagrams illustrating a shielded wire in an embodiment of the present invention, wherein FIG. 1A is a cross sectional view and FIG. 1B is an explanatory diagram illustrating bonding between a metal tape and a resin tape; and

FIG. 2 is a plan view showing a fabric using the shielded wire of FIGS. 1A and 1B.

### DETAILED DESCRIPTION OF THE PREFERRED EMBODIMENT

An embodiment of the invention will be described below in conjunction with the appended drawings.

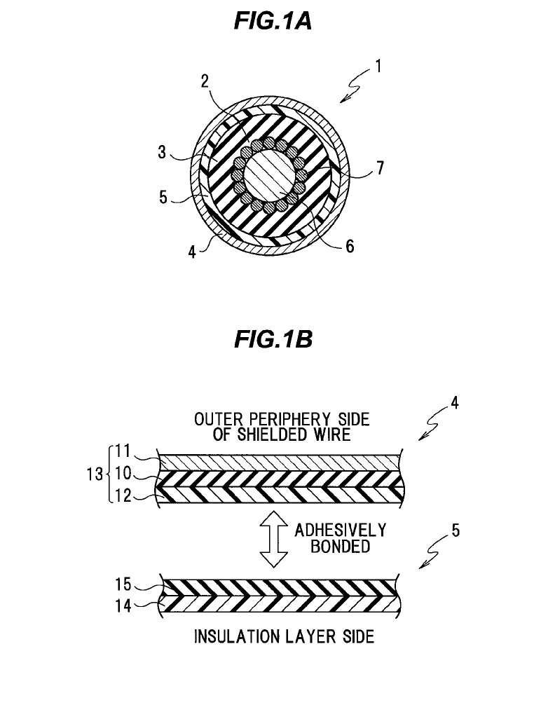

FIGS. 1A and 1B are diagrams illustrating a shielded wire in the present embodiment, wherein FIG. 1A is a cross sectional view and FIG. 1B is an explanatory diagram illustrating bonding between a metal tape and a resin tape.

As shown in FIGS. 1A and 1B, a shielded wire 1 is formed by sequentially providing an insulation layer 3 and a shield (outer conductor) 4 on an outer periphery of a center conductor 2.

In the shielded wire 1 of the present embodiment, the center conductor 2 is formed by spirally winding plural metal strands 7 around a high tensile-strength fiber 6.

Since the high tensile-strength fiber 6 is provided, tension applied to the shielded wire 1 is imposed on the high tensile-strength fiber 6 and this allows the metal strands 7 to be prevented from being broken. The metal strands 7 are likely to be broken especially when sewing the shielded wire 1 into a fabric-like material, etc., since the shielded wire 1 is repeatedly bent with a small curvature radius. However, in the configuration in which the metal strands 7 are wound around the high tensile-strength fiber 6, a tensile load when sewing down the shielded wire 1 is imposed on the high tensile-strength fiber 6 and this allows the metal strands 7 to be prevented from being broken.

The high tensile-strength fiber 6 desirably has a breaking strength of not less than 5N. A polyester fiber such as aromatic polyamide fiber is preferably used as the high tensile-strength fiber 6.

A copper wire or copper alloy wire having an outer diameter of 0.01 to 0.05 mm is used as the metal strand 7. This is because the metal strand 7 with an outer diameter of less than 0.01 mm is likely to be broken, while the metal strand 7 with an outer diameter of more than 0.05 mm causes an increase in an outer diameter of the entire shielded wire 1, which makes sewing work difficult. Desirably, an outer diameter of the entire center conductor 2 is not more than 0.15 mm.

A resin used to form the insulation layer 3 is desirably a fluoropolymer which is excellent in heat resistance and flex resistance and can be applied as thin as not more than 0.1 mm. As a fluoropolymer used to form the insulation layer 3, it is possible to use tetrafluoroethylene-perfluoroalkyl vinyl ether copolymer (PFA), tetrafluoroethylene-hexafluoropropylene copolymer (FEP) or ethylene-tetrafluoroethylene copolymer (ETFE), polypropylene (PP), etc. A dielectric constant and a dielectric loss tangent of the fluoropolymer are small. Therefore, it is possible to suppress an increase in dielectric loss by using the fluoropolymer as a material of the insulation layer 3.

The insulation layer 3 is formed to be filled solid and is applied so as to enter deeply between the plural metal strands 7. The insulation layer 3 is formed by extrusion molding. Appropriately changing the extrusion molding conditions allows the resin constituting the insulation layer 3 to reach around the metal strands 7. Since the insulation layer 3 is applied so as to enter deeply between the plural metal strands 7, adhesion between the insulation layer 3 and the center conductor 2 is enhanced and it is thus possible to suppress separation of the insulation layer 3 from the center conductor 2 when sewing the shielded wire 1 into a material.

Meanwhile, in the shielded wire 1 of the present embodiment, the shield 4 is formed of a metal tape 13 having a metal layer 11 on a surface of a resin layer 10 and is formed by winding the metal tape 13 around the insulation layer 3 so that the metal layer 11 is located on the outer side.

In the present embodiment, a resin tape 5 is wound around the insulation layer 3 and the metal tape 13 is then wound around the resin tape 5, such that the resin tape 5 and the metal tape 13 are adhesively bonded by an adhesive layer(s) provided on one or both of the resin tape 5 and the metal tape 13.

In the present embodiment, the metal tape 13 is composed of the resin layer 10, the metal layer 11 formed on a surface of the resin layer 10 and an adhesive layer 12 formed on another surface of the resin layer 10, the resin tape 5 is composed of a resin layer 14 and an adhesive layer 15 formed on a surface thereof, and the adhesive layers 15 and 12 of the two tapes 5 and 13 are adhered to adhesively bond the resin tape 5 to the metal tape 13.

The resin tape 5 is wound around the insulation layer 3 so that the adhesive layer 15 is located on the outer side. The resin tape 5 is spirally wound in a partially overlapping manner.

The metal tape 13 is wound around the resin tape 5 so that the metal layer 11 is located on the outer side and the adhesive layer 12 on the inner side. The metal tape 13 is spirally wound in a partially overlapping manner.

The adhesive layers 12 and 15 are preferably formed of a heat-seal adhesive. After winding the resin tape 5 and the metal tape 13, the two adhesive layers 15 and 12 are adhered to each other by heating and the resin tape 5 is thereby adhesively bonded to the metal tape 13.

By adhesively bonding the resin tape 5 to the metal tape 13 using the adhesive layers 15 and 12, the two tapes 5 and 13 are integrated and form a pipe-shaped structure. Therefore, defects such as separation of the metal tape 13 at the time of, e.g., sewing the shielded wire 1 into a material can be reduced as compared to the case of using only the metal tape 13.

In addition, since the pipe-shaped structure formed by integrating the two tapes 5 and 13 is not adhesively bonded to the insulation layer 3 and is slidable in a cable longitudinal direction, stress applied to the insulation layer 3 or the center conductor 2 at the time of bending the shielded wire 1 is dispersed and it is thus possible to improve flex resistance.

The metal layer 11 of the metal tape 13 is desirably formed of aluminum which is light in weight and highly conductive. Aluminum is resistant to abrasion and has high weatherability such that an oxide film produced on a surface thereof prevents corrosion or discoloration even if exposed to outside air. This allows desired electrical characteristics to be maintained for a long period of time even without providing a jacket and good appearance to be kept. Therefore, aluminum is suitable as the metal layer 11.

The metal tape 13 used in the present embodiment is an AL/PET tape in which the metal layer 11 of aluminum is formed on one of surfaces of the resin layer 10 of PET (polyethylene terephthalate) and the adhesive layer 12 is formed on another surface of the resin layer 10. Meanwhile, the resin tape 5 used here is a PET tape in which the adhesive layer 15 is formed on a surface of the resin layer 14 of PET.

The aluminum metal layer 11 of the metal tape 13 is desirably not less than 7 μm and not more than 13 μm in thickness. This is because, when the thickness of the metal layer 11 is less than 7 μm, conductor resistance becomes high, causing an increase in loss. On the other hand, flexibility decreases when more than 13 μm.

Meanwhile, the PET resin layer 10 of the metal tape 13 is desirably not less than 4 μm and not more than 6 μim in thickness. This is because the resin layer 10 is likely to be broken when the thickness of the resin layer 10 is less than 4 μm. On the other hand, when more than 6 μm, the entire metal tape 13 becomes thick, a level difference at an overlapping portion thereof becomes large and interferes with surrounding objects when being bent and this may cause defects such as breakage.

A polyester-based heat-seal adhesive, which has high adhesiveness to PET used to form the resin layers 10 and 14 in the present embodiment, is preferably used to form the adhesive layers 12 and 15. Use of the same material to form the adhesive layers 12 and 15 allows for more firm adhesive bonding.

A harness in the present embodiment is composed of the shielded wire 1 in the present embodiment and a terminal component provided on at least one of end portions of the shielded wire 1. Examples of terminal component include circuit boards such as PCB (printed circuit board) or FPC (flexible printed circuit), connectors, flexible flat cables (FFC), multi frame joiners (MFJ) and sensor members, etc.

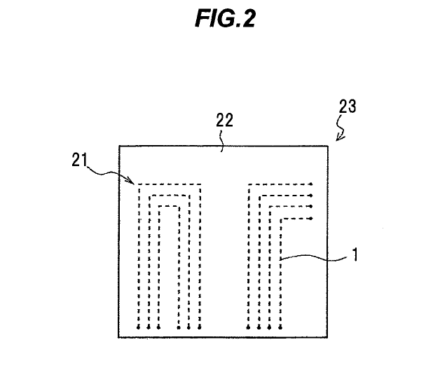

Meanwhile, in an electrical circuit 21 of the present embodiment, the shielded wire 1 is used for wiring, as shown in FIG.2. FIG.2 shows a fabric 23 having the electrical circuit 21 which is formed by sewing the shielded wire 1 into a fabric-like material 22. The shielded wire 1 is sewn, with a desired shape, into the fabric-like material 22 by, e.g., a sewing machine. A garment in the present embodiment is obtained by cutting and sewing the fabric 23.

By sewing the shielded wire 1 on the fabric-like material 22, the shielded wire 1 is integrated with the fabric-like material 22, stress applied when bending or pulling the fabric 23 is absorbed by fibers of the fabric-like material 22 and this prevents the shielded wire 1 from receiving a large stress. Therefore, it is possible to realize a user-friendly electrical circuit 21 which is easily stored, e.g., foldable.

In addition to the application for wiring of the electrical circuit 21, it is possible to use the shielded wire 1 as a sensor portion which detects approach or contact of an object to/with the fabric 23 based on measurement of capacitance between the center conductor 2 and the shield 4.

Furthermore, forming an electrical circuit by sewing the shielded wire 1 into a sheet-shaped base material provides a sheet in the present embodiment even though it is not illustrated. The sheet-shaped base material includes thin films.

Forming the electrical circuit by sewing the shielded wire 1 into the sheet-shaped base material allows a flexible circuit board to be realized more easily at lower cost than conventionally used flexible printed circuit boards.

As described previously, in the shielded wire 1 of the present embodiment, the center conductor 2 is formed by spirally winding plural metal strands 7 around the high tensile-strength fiber 6.

In such a configuration, tension applied to the shielded wire 1 is imposed on the high tensile-strength fiber 6 and this allows the metal strands 7 to be prevented from being broken when, e.g., sewing down the shielded wire 1.

In addition, in the shielded wire 1, the metal tape 13 having the metal layer 11 on a surface of the resin layer 10 is wound around the insulation layer 3, thereby forming the shield 4. This allows the weight of the shielded wire 1 to be reduced as compared to a conventional art using a served shield formed by spirally winding plural copper strands.

Furthermore, in the shielded wire 1, the thin metal tape 13 is used to form the shield 4 and a jacket is not provided. This allows the diameter of the shielded wire 1 to be reduced and it is thus possible to realize the shielded wire 1 which is easy to sew into a material and easy to handle.

In addition, unlike the conventional wire using a served shield in which copper strands are fractured and broken due to bending fatigue, there is no such a risk in the shielded wire 1 since the metal tape 13 is used to form the shield 4 and flex life of the shielded wire 1 is thus long. In addition, it is possible to omit work of producing and winding very thin copper strands unlike the conventional technique, it is possible to form the shield 4 only by winding the metal tape 13 and it is also possible to eliminate a jacket manufacturing process. Therefore, it is easy to manufacture at low cost.

The invention is not intended to be limited to the embodiment, and it is obvious that the various kinds of modifications can be implemented without departing from the gist of the invention.

What is claimed is:

1. A shielded wire, comprising:
a center conductor; and
an insulation layer and a shield that are sequentially formed on an outer periphery of the center conductor,
wherein the center conductor comprises a high tensile-strength fiber and a plurality of metal strands wound around the high tensile-strength fiber.

2. The shielded wire according to claim 1, wherein the insulation layer comprises a solid material of a fluoropolymer, and
wherein the insulation layer is formed so as to be buried between the plural metal strands.

3. The shielded wire according to claim 1, wherein the shield comprises a metal tape wound on the insulation layer, and
wherein the metal tape comprises a resin layer and a metal layer formed on one side of the resin layer.

4. The shielded wire according to claim 3, wherein the shield further comprises a resin tape wound on the insulation layer, the metal tape being wound around the resin tape so that the metal layer is located on an outer side, and
the resin tape and the metal tape are adhesively bonded by an adhesive layer provided on one or both of the resin tape and the metal tape.

5. The shielded wire according to claim 3, wherein the metal layer comprises aluminum.

6. A harness, comprising:
the shielded wire according to claim 1; and
a terminal component provided on at least one of end portions of the shielded wire.

7. An electrical circuit, comprising a wiring comprising the shielded wire according to claim 1.

8. A fabric, comprising:
a fabric material; and
the shielded wire according to claim 1 that is sewn into the fabric material.

9. A garment, comprising the fabric according to claim 8 that is cut and sewn.

10. A sheet, comprising:
a sheet-shaped base material; and
the shielded wire according to claim 1 that is sewn into the sheet-shaped base material.
